(19) United States
(12) Patent Application Publication
(10) Pub. No.: US 2021/0198486 A1
(43) Pub. Date: Jul. 1, 2021

(54) POLYURETHANE WITH (5-ALKYL -1,3-DIOXOLEN-2-ONE-4-YL) END GROUPS AND USES THEREOF

(71) Applicant: Bostik SA, Colombes (FR)

(72) Inventors: Guillaume MICHAUD, Venette (FR); Frédéric SIMON, Venette (FR); Stéphane FOUQUAY, Venette (FR)

(21) Appl. No.: 16/764,418

(22) PCT Filed: Nov. 21, 2018
(86) PCT No.: PCT/FR2018/052941

§ 371 Date: May 15, 2020

(30) Foreign Application Priority Data
Nov. 22, 2017 (FR) 1761031

(51) Int. Cl. C08L 75/08; C08G 18/10; C08G 18/28; C08G 18/48; C08G 18/73; C08G 18/78

(52) U.S. Cl. CPC C08L 75/08; C08G 18/10; C08G 18/7837; C08G 18/4825; C08G 18/73; C08G 18/2815

(57) ABSTRACT

The present invention relates to a polyurethane (PP2) comprising at least two end functions T of formula (I) and at least CN one divalent unit of formula (II), as well as its uses, in particular for preparing adhesive compositions.

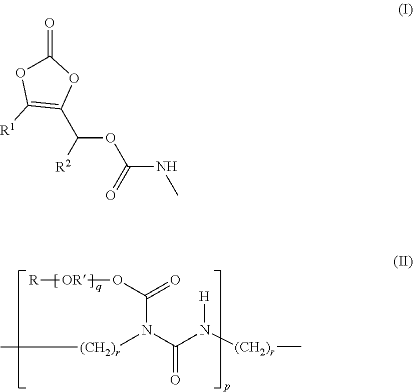

### FIELD OF THE INVENTION

The present invention relates to a polyurethane with (5-alkyl-1,3-dioxolen-2-one-4-yl) end groups, and the process for preparing same.

The present invention also relates to a multicomponent system comprising said polyurethane.

The invention also relates to a process for assembling materials by adhesive bonding, using said polyurethane.

### TECHNOLOGICAL BACKGROUND

Polyurethane-based adhesive (glue or mastic) compositions, in particular in the form of multicomponent (generally two-component) systems in which the (two) reactive components necessary for the synthesis of the polyurethane are stored separately and mixed at the final moment before use of the adhesive composition, have been known for a long time.

In order for such a system to be correctly employed, it is preferable for the reactive components to have, on the one hand, a sufficient reactivity for the reaction to take place and to be implemented rapidly and, on the other hand, a viscosity suited to the mixing temperature, in order for the mixing to be easily implemented.

Conventionally, the synthesis of a polyurethane takes place by a polyaddition reaction between a polyol and a polyisocyanate.

However, polyisocyanates are compounds which are very sensitive in the presence of atmospheric moisture and require that appropriate measures be taken in order to prevent them from crosslinking prematurely and thus losing their reactivity during the handling and storage thereof (anhydrous conditions). Furthermore, some of these compounds, such as hexamethylene diisocyanate (HDI), isophorone diisocyanate (IPDI), toluene diisocyanate (TDI) or diphenylmethane diisocyanate (MDI), are known as exhibiting toxicological risks to man and the environment and the most volatile can even generate toxic emissions.

The use and the storage of large amounts of such polyisocyanates is thus to be avoided as this requires the installation of complex and expensive safety devices suited to their use and their storage. In particular, it is desirable to avoid having recourse to such compounds during the final step of synthesis of the polyurethane, in order to be able to make available to the public polyurethane-based adhesive compositions in the form of multicomponent systems which are more friendly to man and his environment and more stable in storage.

In addition, when it is desired to formulate compositions in the form of a kit which is transportable, practical and easy and rapid to employ on demand (Do It Yourself), the mixing of the reactants has to be able to be carried out as much as possible on restricted volumes and at low temperature, in particular at room temperature.

WO 2015/140457 describes multi-component systems, and in particular two-component systems, obtained by mixing a component A comprising at least one polyurethane prepolymer functionalized with glycerol carbonate at the chain end with a component B comprising at least two primary and/or secondary amine groups. Although these compositions have the advantage of not using polyisocyanate during the mixing of components A and B, the reaction of the (2-oxo-1,3-dioxolan-4-yl) groups of component A with the primary and/or secondary amine groups of component B is slow at low temperature. It is therefore necessary to mix said components at a high temperature, for example at 80° C. Thus, such systems remain to be improved in terms of reactivity.

Consequently, there is a need to provide polyurethane-based compositions that do not have the disadvantages of the prior art. More particularly, there is a need for novel polyurethane-based compositions that have a better reactivity at low temperature, while retaining satisfactory adhesive properties.

There is also a need to formulate polyurethane-based compositions, available in the form of multicomponent and in particular two-component systems, which are easier to use in comparison with the prior art, at mixing and reaction temperatures below 60° C., preferably below or equal to 35° C., and more preferentially close to room temperature (23° C.).

In particular, there is a need to find compositions available in the form of multicomponent systems, in particular transportable systems (kits), which are friendly to man and the environment.

There is also a need to provide multicomponent systems, the use of which results in adhesive compositions, in particular glue or mastic compositions, having mechanical performance (for example, elongation and/or modulus performance) suited to the use of the adhesive composition.

There is also a need to develop a process for preparing such adhesive compositions which is economical, rapid to carry out and friendly to man and the environment. Desired in particular is a process for preparing such compositions which is not very expensive in terms of energy and which does not use a large amount of solvent.

### DESCRIPTION OF THE INVENTION

In the present patent application, unless otherwise indicated:
the amounts expressed in the percentage form correspond to weight/weight percentages;
the number-average molar masses, expressed in grams per mole (g/mol), are determined by calculation by the analysis of the content of end (NCO, OH and T function) groups, expressed in milliequivalents per gram (meq/g), and the functionality (number of NCO, OH functions or T functions per mole) of the compound under consideration (compound (PP1), polyether polyol, compound of formula (IV) or polyurethane comprising at least two T end functions (PP2) respectively);
the hydroxyl number of an alcoholic product represents the number of hydroxyl functions per gram of product, and is expressed in the form of the equivalent number of milligrams of potassium hydroxide (KOH) used in the assay of the hydroxyl functions, per gram of product;
the measurement of viscosity at 23° C. may be carried out using a Brookfield viscometer according to standard ISO 2555. Typically, the measurement made at 23° C. may be carried out using a Brookfield RVT viscometer with a spindle suitable for the viscosity range and at a rotational speed of 20 revolutions per minute (rpm);
the measurement of viscosity at 60° C. can be carried out using a Brookfield RVT viscometer coupled with a heating module of Thermosel type of the Brookfield brand, with a spindle suited to the viscosity range and at a rotational speed of 20 revolutions per minute.

### A. Polyurethane

The present invention relates to a polyurethane (PP2) comprising:

at least two, preferably two or three, T end functions of formula (I) below:

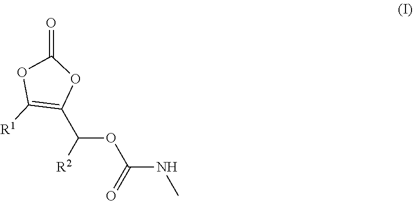

wherein R¹ and R², which are identical or different, each represent a hydrogen atom, a linear or branched alkyl group, preferably a C1-C6 alkyl group, a cycloalkyl group, preferably a C5-C6 cycloalkyl group, a phenyl group, preferably a C6-C12 phenyl group, or an alkylphenyl group with a linear or branched alkyl chain, preferably a C1-C4 alkyl chain; or R¹ and R² may be bonded together to form a —(CH₂)ₙ— group with n=3, 4 or 5, and

at least one divalent unit of formula (II) below:

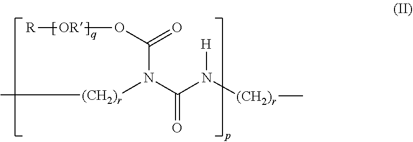

wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms; and
R′ represents a linear or branched, saturated, divalent hydrocarbon group having from 2 to 4 carbon atoms.

Preferably, the abovementioned polyurethane (PP2) further comprises at least one of the following divalent radicals R³:
a) the —(CH₂)₅— divalent radical derived from pentamethylene diisocyanate (PDI);
b) the —(CH₂)₆— divalent radical derived from hexamethylene diisocyanate (HDI);
c) the divalent radical derived from isophorone:

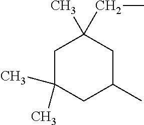

d) the divalent radical derived from TDI;
e) the divalent radical derived from MDI;
f) the divalent radical derived from xylylene diisocyanate (XDI);
g) the divalent radical derived from 1,3-bis(isocyanatomethyl)cyclohexane (m-H6XDI):

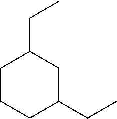

h) the divalent radical derived from 4,4′-methylene dicyclohexyl diisocyanate (H12MDI):

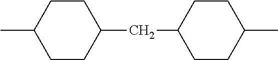

Preferably, the abovementioned polyurethane (PP2) further comprises at least one of the following divalent radicals R³:

a) the —(CH₂)₅— divalent radical derived from pentamethylene diisocyanate (PDI);

b) the —(CH₂)₆— divalent radical derived from hexamethylene diisocyanate (HDI);

c) the divalent radical derived from isophorone:

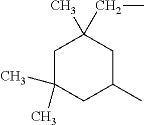

d) the divalent radical derived from 2,4-TDI:

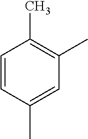

e) the divalent radical derived from 2,4′-MDI:

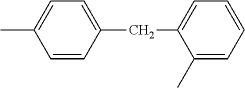

f) the divalent radical derived from meta-xylylene diisocyanate (m-XDI):

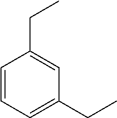

g) the divalent radical derived from 1,3-bis(isocyanatomethyl)cyclohexane (m-H6XDI):

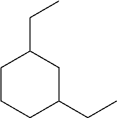

h) the divalent radical derived from 4,4′-methylene dicyclohexyl diisocyanate (H12MDI):

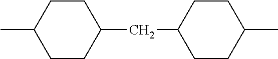

Preferably, the abovementioned polyurethane (PP2) comprises at least one repeat unit comprising at least one of the divalent radicals R³ as described above.

According to one embodiment, the abovementioned polyurethane (PP2) has the following formula (III):

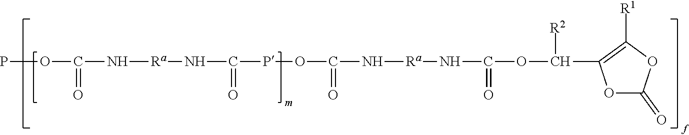

wherein:
R¹ and R² are as defined above, R¹ preferably being a methyl and R² preferably being a hydrogen atom;
P represents one of the two formulae below:

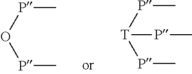

wherein D and T represent, independently of one another, a linear or branched, cyclic, alicyclic or aromatic, saturated or unsaturated hydrocarbon radical comprising from 2 to 66 carbon atoms, optionally comprising one or more heteroatoms;
P′ and P″ being, independently of one another, a divalent radical derived from a polyol preferably selected from polyether polyols, polycarbonate polyols, polyester polyols, polydiene polyols, and mixtures thereof, the polyols being preferentially those described below for step E1;
m and f are integers such that the average molecular mass of the polyurethane ranges from 600 to 100 000 g/mol;
f is equal to 2 or 3;
R^{a} represents a divalent radical selected from the R³ radicals as defined above, and the divalent unit of formula (II) as defined above, at least one R^{a} being a divalent unit of formula (II).

According to one embodiment, the abovementioned polyurethane (PP2) has the following formula (III′):

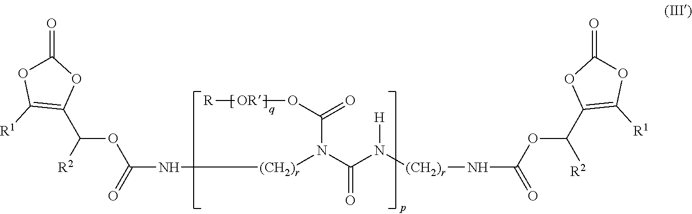

wherein R¹, R², R, R¹, r, q and p are as defined above.

The abovementioned polyurethane (PP2) may have a viscosity measured at room temperature (23° C.) of less than or equal to 1500 Pa·s, more preferentially less than or equal to 600 Pa·s, and better still less than or equal to 400 Pa·s.

The abovementioned polyurethane (PP2) may have a viscosity measured at 60° C. of less than or equal to 50 Pa·s, more preferentially less than or equal to 40 Pa·s, and better still less than or equal to 30 Pa·s.

Preferably, the abovementioned polyurethane (PP2) has a viscosity, measured at room temperature (23° C.), of less than or equal to 600 Pa·s and a viscosity, measured at 60° C., of less than or equal to 40 Pa·s.

The abovementioned polyurethane (PP2) comprising at least two T end functions can be obtained by reaction of a compound (PP1) comprising at least two NCO groups and at least one divalent unit of abovementioned formula (II), with at least one compound of formula (IV) below:

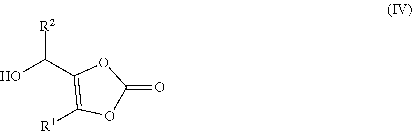

wherein R¹ and R², which are identical or different, each represent a hydrogen atom, a linear or branched alkyl group, preferably a C1-C6 alkyl group, a cycloalkyl group, preferably a C5-C6 cycloalkyl group, a phenyl group, preferably a C6-C12 phenyl group, or an alkylphenyl group with a linear or branched alkyl chain, preferably a C1-C4 alkyl chain; or R¹ and R² may be bonded together to form a —(CH₂)ₙ— group with n=3, 4 or 5.

The compounds of formula (IV) can be synthesized as described in EP0078413, for example according to the following scheme:

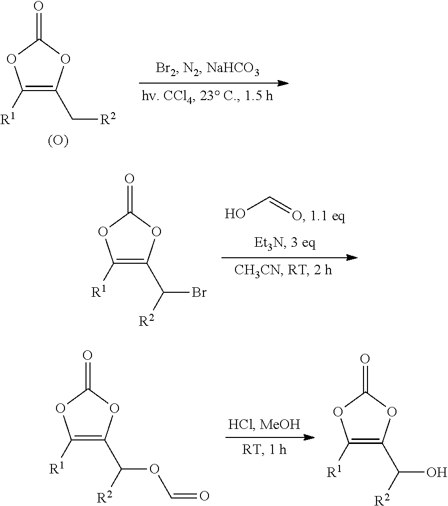

The abovementioned compound (O) can be synthesized by the methods described in Liebigs Annalen der Chemie, Vol. 764, pp. 116-124 (1972), Tetrahedron Letters, 1972, pages 1701-1704 or U.S. Pat. No. 3,020,290.

The compounds of formula (IV) may also be prepared as described in WO 96/02253.

According to a preferred embodiment, the compounds of formula (IV) are those corresponding to the formula (IV-1) below:

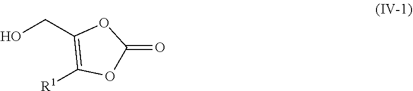

wherein R¹ is as defined above. The compounds of formula (IV-1) are compounds of formula (IV) wherein R² is a hydrogen.

According to a preferred embodiment, the compounds of formula (IV) have the following formula (IV-1a):

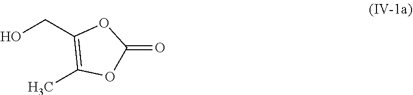

The compound of formula (IV-1a) is 4-hydroxymethyl-5-methyl-1,3-dioxolen-2-one.

The compound of formula (IV-1a) is a compound of formula (IV) wherein R² is a hydrogen, and R¹ is a methyl. The compound of formula (IV-1a) can be obtained as described in WO 96/02253, namely in particular according to the following scheme:

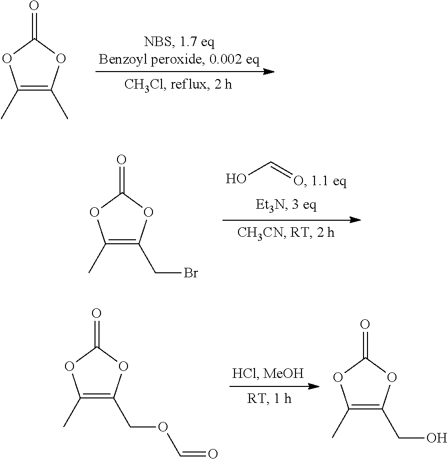

### B. Process

The present invention also relates to a process for preparing an abovementioned polyurethane (PP2) comprising a step of polyaddition reaction (denoted E2):
of at least one compound (PP1) having at least two NCO groups and at least one divalent unit of formula (II):

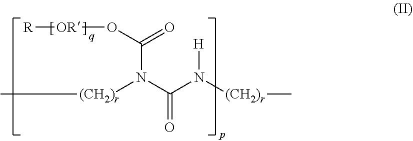

wherein:
   p is an integer ranging from 1 to 2;
   q is an integer ranging from 0 to 9;
   r is an integer equal to 5 or 6;
   R represents a saturated or unsaturated, cyclic or acyclic, linear or branched hydrocarbon chain comprising from 1 to 20 carbon atoms;
   R′ represents a linear or branched, saturated, divalent hydrocarbon group having from 2 to 4 carbon atoms;
with at least one compound of formula (IV),
   in amounts of compound(s) (PP1) and of compound(s) of formula (IV) resulting in an NCO/OH molar ratio, denoted r₂, of less than or equal to 1, preferably ranging from 0.8 to 1 and preferentially from 0.85 to 1.0.

Within the context of the invention, and unless otherwise mentioned, r₂ is the NCO/OH molar ratio corresponding to the molar ratio of the number of isocyanate groups to the number of hydroxyl groups borne respectively by all of the isocyanate(s) (compound(s) (PP1) and optionally the polyisocyanate(s) which have not reacted at the end of step E1), and alcohol(s) present in the reaction medium of step E2.

### Step E2

The compound of formula (IV) that can be used to prepare the polyurethane (PP2) according to the invention can be used either pure or in the form of a mixture or composition of compounds of formula (IV) containing at least 95% by weight of compound of formula (IV).

The compound (PP1) used has a content of NCO groups preferably ranging from 0.5% to 15% by weight of said compound.

The compound(s) (PP1) used can be employed either pure or in the form of a composition essentially comprising said compound(s) and a low content of residual polyisocyanate compound(s) resulting from the synthesis of said compound(s). In the latter case, the compound(s) (PP1) used is (are) such that the content of NCO groups present in said composition preferably ranges from 0.5% to 15% by weight relative to the weight of said composition.

According to an embodiment, the compound(s) (PP1) having at least two NCO groups and at least one divalent unit of formula (II) as defined above is (are) preferably selected from the hexamethylene diisocyanate (HDI) allophanate derivatives of formula (IIA) below:

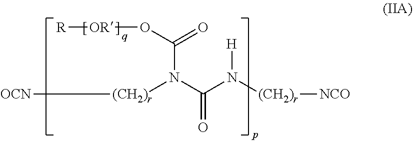

wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms;
R′ represents a linear or branched, saturated, divalent hydrocarbon group having from 2 to 4 carbon atoms.

Preferably, p, q, R and R′ are selected such that the HDI allophanate derivative of formula (IIA) comprises a percentage by weight of isocyanate group ranging from 12% to 14% by weight relative to the weight of said derivative. More preferentially,
p is an integer ranging from 1 to 2;
q is an integer ranging from 2 to 5;
R represents a saturated or unsaturated, cyclic or acyclic, linear or branched hydrocarbon chain comprising from 6 to 14 carbon atoms;
R′ represents a divalent propylene group.

The compound (PP1) which can be used according to the invention can be employed pure or in the form of a composition or mixture essentially containing at least one derivative of formula (IIA) and a low content of residual polyisocyanate compound(s) resulting from the synthesis of said derivative. The content of residual polyisocyanate compound(s) tolerated (corresponding to the HDI) is such that the use of said mixture advantageously has no impact on the final properties of the polyurethane (PP2).

In particular, the compound (PP1) which can be used according to the invention can be employed in the form of a composition comprising at least 99.5% by weight, preferably at least 99.8% by weight, of derivative(s) of formula (II A) and less than 0.5% by weight, preferably less than 0.2% by weight, of HDI relative to the total weight of said composition.

Such a composition can be obtained, for example, by:

carbamation reaction ranging from 80° C. to 100° C. of a saturated or unsaturated, acyclic, linear or branched monoalcohol comprising from 1 to 20 carbon atoms which is oxyalkylated, the alkylene portion of which is linear or branched and comprises from 1 to 4 carbon atoms, with a first HDI monomer in an NCO/OH molar ratio of greater than 2, advantageously of greater than 4, preferably of greater than 8, then

allophanation reaction at a temperature ranging from 100° C. to 180° C., preferably in the vicinity of 140° C., of the carbamate compound obtained having a hydroxyl function with a second HDI monomer in an NCO/OH molar ratio of from 5 to 20, and

distillation of the unreacted HDI monomers, in order to obtain a reactant comprising less than 0.5% by weight of HDI, preferably less than 0.2% by weight of HDI.

Preferably, the content of NCO groups (also designated by “degree of NCO” and denoted % NCO) present in the composition of derivative(s) of formula (IIA) ranges from 12% to 14% by weight relative to the weight of said composition.

“Content of NCO groups present in the composition” (also designated by “degree of NCO”, denoted % NCO) is understood to mean the content of isocyanate groups borne by all of the compounds present in the composition (compound (PP1) and the other entities bearing isocyanate group(s) present, such as unreacted polyisocyanate (HDI) monomers). This content of NCO groups can be calculated in a way well known to a person skilled in the art and is expressed as a percentage by weight relative to the total weight of the reaction medium.

The derivative of formula (IIA) which can be used to prepare the polyurethane (PP2) according to the invention is sold in particular under the name “Tolonate®” by Vencorex. Mention may in particular be made of “Tolonate® X FLO 100”, corresponding to a composition comprising at least 99.5% by weight of HDI allophanate derivative of formula (IIA) and less than 0.5% by weight of HDI relative to the weight of said composition.

By way of example of a compound of formula (IV), mention may be made of 4-hydroxymethyl-5-methyl-1,3-dioxolen-2-one available from Fluorochem and Oxchem with a molar mass of 130.1 g/mol and a hydroxyl number close to 431 mg KOH/g of composition.

When the compound (PP1) used and/or the compound of formula (IV) used is or are in the form of a composition or mixture essentially comprising said compound(s) (PP1) and/or compound(s) of formula (IV) respectively, as described above, the calculation of the ratio r2 takes into account, on the one hand, the NCO groups borne by the compound (PP1) but also the isocyanates possibly as a mixture with the compound(s) (PP1) and/or, on the other hand, the OH groups borne by the compound(s) of formula (IV) but also the residual polyol compound(s) possibly as a mixture with the compound(s) of formula (IV).

Step E2 can be carried out at a temperature T2 below 95° C., and/or under anhydrous conditions.

At the end of step E2, the reaction medium is preferably free of potentially toxic diisocyanate (HDI) monomers. In this case, the polyurethane (PP2) according to the invention advantageously exhibits no toxicological risks related to the presence of such monomers.

At the end of step E2, the polyurethane (PP2) according to the invention preferably has from 0.1 to 5, preferably from 2 to 3 milliequivalents of T functions per gram of said polyurethane (PP2).

### Step E1

According to another embodiment, the compound(s) (PP1) having at least two NCO groups and at least one divalent unit of formula (II) as defined above is (are) preferably selected from the polyurethanes having NCO end groups capable of being obtained by a polyaddition reaction (denoted step E1):

(i) of a polyisocyanate(s) composition, and in particular diisocyanates composition, comprising at least one hexamethylene diisocyanate (HDI) allophanate derivative of formula (IIA) as defined previously, and
(ii) with a polyol(s) composition, said polyol(s) being preferably selected from polyether polyols, polyester polyols, polydiene polyols, polycarbonate polyols, and mixtures thereof, and preferentially from polyether polyols,
in amounts of polyisocyanate(s) and of polyol(s) resulting in an NCO/OH molar ratio, denoted r1, of strictly greater than 1, and preferably ranging from 1.6 to 1.9.

Within the context of the invention, and unless otherwise mentioned, n is the NCO/OH molar ratio corresponding to the molar ratio of the number of isocyanate groups (NCO) to the number of hydroxyl groups (OH) borne respectively by all of the polyisocyanate(s) and polyol(s) present in the reaction medium of step E1.

In the case where the compound (PP1) is a polyurethane with NCO end groups derived from step E1, the polyurethane (PP2) obtained preferably has from 0.1 to 1.5 milliequivalent(s) of T functions per gram of said polyurethane (PP2), more preferentially from 0.15 to 1 milliequivalent of T functions of said polyurethane (PP2) and better still from 0.2 to 0.8 milliequivalent of T functions per gram of said polyurethane (PP2).

The abovementioned polyurethane (PP1) may further comprise at least one of the following divalent radicals R³, preferably may comprise at least one repeat unit comprising at least one of the following radicals R³:

a) the —(CH₂)₅— divalent radical derived from pentamethylene diisocyanate (PDI);

b) the —(CH₂)₆— divalent radical derived from hexamethylene diisocyanate (HDI);

c) the divalent radical derived from isophorone:

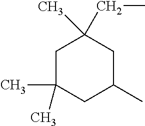

d) the divalent radical derived from 2,4-TDI:

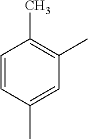

e) the divalent radical derived from 2,4′-MDI:

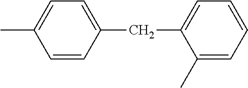

f) the divalent radical derived from meta-xylylene diisocyanate (m-XDI):

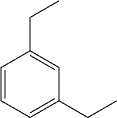

g) the divalent radical derived from 1,3-bis(isocyanatomethyl)cyclohexane (m-H6XDI):

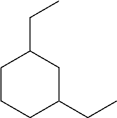

h) the divalent radical derived from 4,4′-methylene dicyclohexyl diisocyanate (H12MDI):

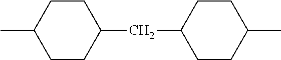

At the end of step E1, the polyurethane with NCO end groups (compound PP1) obtained is such that the content of NCO groups (also designated by “degree of NCO” and denoted % NCO) present in the reaction medium of step E1 preferably ranges from 0.5% to 5.7%, more preferentially from 0.7% to 3% and better still from 1% to 2.5%, relative to the weight of the reaction medium of step E1.

“Content of NCO groups present in the reaction medium” (also designated by “degree of NCO”, denoted % NCO) is understood to mean the content of isocyanate groups borne by all of the compounds present in the reaction medium, namely the polyurethane with NCO end groups (compound PP1) formed and the other entities bearing isocyanate group(s) present in the abovementioned polyisocyanates composition and which have not reacted. This content of NCO groups can be calculated in a way well known to a person skilled in the art and is expressed as a percentage by weight relative to the total weight of the reaction medium.

### Polyisocyanates

The abovementioned polyisocyanate(s) composition preferably comprises, in addition to the hexamethylene diisocyanate (HDI) allophanate derivative(s) of formula (IIA), at least one different diisocyanate selected, for example, from IPDI, PDI, HDI, TDI (and preferably 2,4-TDI), MDI (and preferentially 2,4′-MDI), XDI (and in particular m-XDI), m-H6XDI, H12MDI, and mixtures thereof, preferably from IPDI, 2,4-TDI, 2,4′-MDI, m-XDI and mixtures thereof.

According to a preferred embodiment, the compound(s) (PP1) having at least two NCO groups is (are) preferably selected from the polyurethanes having NCO end groups capable of being obtained by a polyaddition reaction (denoted E1):

(i) of a polyisocyanate(s) composition consisting of at least one hexamethylene diisocyanate (HDI) allophanate derivative of formula (IIA) as defined above and optionally of at least one diisocyanate selected from:
a1) isophorone diisocyanate (IPDI) (the percentage by weight of isocyanate group of which is equal to 38% by weight approximately relative to the weight of IPDI),
a2) 2,4-toluene diisocyanate (2,4-TDI) (the percentage by weight of isocyanate group of which is equal to 48% by weight approximately relative to the weight of 2,4-TDI),
a3) 2,4′-diphenylmethane diisocyanate (2,4′-MDI) (the percentage by weight of isocyanate group of which is equal to 34% by weight approximately relative to the weight of 2,4′-MDI),
a4) meta-xylylene diisocyanate (m-XDI),
a5) 1,3-bis(isocyanatomethyl)cyclohexane (m-H6XDI);
a6) 4,4′-methylene dicyclohexyl diisocyanate (H12MDI);
a7) and mixtures thereof, preferably the at least one diisocyanate is selected from diisocyanates a1) to a4) and mixtures thereof,
   (ii) with at least one polyol, preferably selected from polyether polyols, polyester polyols, polydiene polyols, polycarbonate polyols, and mixtures thereof, preferentially from polyether polyols,
   optionally in the presence of a reaction catalyst, and
   in amounts of polyisocyanate(s) and of polyol(s) resulting in an NCO/OH molar ratio, r1, of strictly greater than 1, and preferably ranging from 1.6 to 1.9, preferentially ranging from 1.65 to 1.85.

The polyisocyanate(s) cited in a2) and a3) which can be used in the polyisocyanate(s) composition (i) may be employed in the form of a mixture essentially containing said polyisocyanate(s) and a low content of residual polyisocyanate compound(s) (corresponding to the isomers of 2,4-TDI and of 2,4′-MDI respectively) resulting from the synthesis of said polyisocyanate(s) cited in a2) and a3). The content of residual polyisocyanate compound(s) tolerated is such that the use of said mixture advantageously has no impact on the final properties of the polyurethane (PP2).

For example, the polyisocyanate(s) cited in a2) and a3) which can be used in the polyisocyanate(s) composition (i) can be employed in the form of a mixture containing at least 99% by weight of polyisocyanate(s) and less than 1% by weight of residual polyisocyanate compound(s), preferably in the form of a mixture containing at least 99.5% by weight of polyisocyanate(s) and less than 0.5% by weight of residual polyisocyanate compound(s), more preferentially in the form of a mixture containing at least 99.8% by weight of polyisocyanate(s) and less than 0.2% by weight of residual polyisocyanate compound(s) relative to the weight of said mixture.

Preferably, the content of residual polyisocyanate compound(s) is such that the content by weight of isocyanate group in said mixture remains approximately equal to that indicated above relative to the weight of the diisocyanate a2) and a3) alone.

Thus, the 2,4-TDI as cited in a2) can be used in the form of a commercially available industrial TDI corresponding to a composition, the 2,4-TDI content of which is at least 99% by weight and preferably at least 99.5% by weight relative to the weight of said composition.

The 2,4′-MDI as cited in a3) can be used in the form of a commercially available industrial MDI corresponding to a composition, the 2,4′-MDI content of which is at least 99% by weight and preferably at least 99.5% by weight relative to the weight of said composition.

The diisocyanate(s) cited in a1), a2), a3), a4), a5) and a6) which can be used in the diisocyanate(s) composition (i) to prepare the compound (PP1) used according to the invention are widely available commercially. By way of example, mention may be made of “Scuranate® T100” sold by Vencorex, corresponding to a 2,4-TDI having a purity of greater than 99% by weight, “Desmodur® I” sold by Bayer, corresponding to an IPDI, “Takenate™ 500” sold by Mitsui Chemicals corresponding to an m-XDI, “Takenate™ 600” sold by Mitsui Chemicals corresponding to an m-H6XDI, “Vestanat® H12MDI” sold by Evonik corresponding to an H12MDI.

### Polyols

The abovementioned polyol(s) composition may comprise at least one polyol selected from the group consisting of polyether polyols, polyester polyols, polydiene polyols, polycarbonate polyols, and mixtures thereof.

Preferably, the polyol(s) is (are) selected from polyether polyols.

The polyol(s) which can be used to prepare the polyurethane having NCO end groups used according to the invention can be selected from those for which the number-average molecular mass ranges from 200 to 20 000 g/mol, preferably from 250 to 18 000 g/mol and better still from 2000 to 12 000 g/mol.

Preferably, their hydroxyl functionality ranges from 2 to 3. The hydroxyl functionality is the mean number of hydroxyl functions per mole of polyol.

Preferably, the polyol(s) which can be used according to the invention has (have) a hydroxyl (OHN) ranging from 9 to 105 mg KOH/g, and preferably from 13 to 90 mg KOH/g, more preferentially from 25 to 70 mg KOH/g and better still from 40 to 65 mg KOH/g of polyol.

The polyether polyol(s) which can be used according to the invention is (are) preferably selected from polyoxyalkylene polyols, the linear or branched alkylene portion of which comprises from 1 to 4 carbon atoms, preferably from 2 to 3 carbon atoms.

More preferentially, the polyether polyol(s) which can be used according to the invention is (are) preferably selected from polyoxyalkylene diols or polyoxyalkylene triols and better still polyoxyalkylene diols, the linear or branched alkylene portion of which comprises from 1 to 4 carbon atoms, preferably from 2 to 3 carbon atoms, and the average molecular mass of which ranges from 200 to 20 000 g/mol and preferably from 2000 to 12 000 g/mol.

Mention may be made, as examples of polyoxyalkylene diols or triols which can be used according to the invention, of:
polyoxypropylene diols or triols (also denoted by polypropylene glycol (PPG) diols or triols) having an average molecular mass ranging from 400 to 18 000 g/mol and preferably ranging from 400 to 4000 g/mol;
polyoxyethylene diols or triols (also denoted by polyethylene glycol (PEG) diols or triols) having an average molecular mass ranging from 400 to 18 000 g/mol and preferably ranging from 400 to 4000 g/mol;
PPG/PEG copolymer diols or triols having an average molecular mass ranging from 400 to 18 000 g/mol and preferably ranging from 400 to 4000 g/mol;
polytetrahydrofuran (PolyTHF) diols or triols having an average molecular mass ranging from 250 to 4000 g/mol;
and mixtures thereof.

Preferably, the polyether polyol(s) which can be used is (are) selected from polyoxypropylene diols or triols with a polydispersity index ranging from 1 to 1.4, in particular ranging from 1 to 1.3. This index corresponds to the ratio of the weight-average molecular mass to the number-average molecular mass of the polyether polyol (PI=Mw/Mn), determined by GPC.

The abovementioned polyether polyols may be prepared conventionally and are widely available commercially. They can be obtained by polymerization of the corresponding alkylene oxide in the presence of a catalyst based on a double metal/cyanide complex.

Mention may be made, as examples of polyether diols, of the polyoxypropylene diols sold under the name “Acclaim®” by Covestro, such as “Acclaim® 12200”, with a number-average molecular mass in the vicinity of 11 335 g/mol and the hydroxyl number of which ranges from 9 to 11 mg KOH/g, “Acclaim® 8200”, with a number-average molecular mass in the vicinity of 8057 g/mol and the hydroxyl number of which ranges from 13 to 15 mg KOH/g, and “Acclaim® 4200”, with a number-average molecular mass in the vicinity of 4020 g/mol and the hydroxyl number of which ranges from 26.5 to 29.5 mg KOH/g, or else the polyoxypropylene diol sold under the name “Voranol P2000” by Dow, with a number-average molecular mass in the vicinity of 2004 g/mol and the hydroxyl number of which is 56 mg KOH/g approximately.

Mention may be made, as examples of polyether triols, of the polyoxypropylene triol sold under the name “Voranol CP3355” by Dow, with a number-average molecular mass in the vicinity of 3554 g/mol and the hydroxyl number of which ranges from 40 to 50 mg KOH/g.

The polydiene polyol(s) that can be used according to the invention is (are) preferably selected from polydienes containing hydroxyl end groups, and the corresponding hydrogenated or epoxidized derivatives thereof.

More preferentially, the polydiene polyol(s) that can be used according to the invention is (are) selected from polybutadienes comprising hydroxyl end groups, which are optionally hydrogenated or epoxidized.

Better still, the polydiene polyol(s) that can be used according to the invention is (are) selected from butadiene homopolymers comprising hydroxyl end groups, which are optionally hydrogenated or epoxidized.

The term “end” is understood to mean that the hydroxyl groups are located at the ends of the main chain of the polydiene polyol.

The abovementioned hydrogenated derivatives can be obtained by complete or partial hydrogenation of the double bonds of a polydiene containing hydroxyl end groups, and are therefore saturated or unsaturated.

The aforementioned epoxidized derivatives can be obtained by chemoselective epoxidation of the double bonds of the main chain of a polydiene comprising hydroxyl end groups, and therefore comprise at least one epoxy group in its main chain.

As examples of polybutadiene polyols, mention may be made of saturated or unsaturated butadiene homopolymers, comprising hydroxyl end groups, which are optionally epoxidized, such as for example those sold under the name Poly BD® or Krasol® by Cray Valley.

The polyester polyols may be selected from polyester diols and polyester triols, and preferably from polyester diols.

Among the polyester polyols, mention may for example be made of:

polyester polyols of natural origin, such as castor oil;

polyester polyols resulting from the condensation of:
one or more aliphatic (linear, branched or cyclic) or aromatic polyols such as for example ethanediol, 1,2-propanediol, 1,3-propanediol, glycerol, trimethylolpropane, 1,6-hexanediol, 1,2,6-hexanetriol, butenediol, sucrose, glucose, sorbitol, pentaerythritol, mannitol, triethanolamine, N-methyldiethanolamine, and mixtures thereof, with
one or more polycarboxylic acids or an ester or anhydride derivative thereof, such as 1,6-hexanedioic acid, dodecanedioic acid, azelaic acid, sebacic acid, adipic acid, 1,18-octadecanedioic acid, phthalic acid, succinic acid and mixtures of these acids, an unsaturated anhydride such as for example maleic or phthalic anhydride, or a lactone such as for example caprolactone.

The abovementioned polyester polyols may be prepared conventionally and are for the most part commercially available.

Among the polyester polyols, mention may for example be made of the following products with hydroxyl functionality equal to 2:

Tone® 0240 (available from Union Carbide), which is a polycaprolactone with a number-average molecular mass of around 2000 g/mol, and a melting point of around 50° C.,

Dynacoll®7381 (available from Evonik) with a number-average molecular mass of around 3500 g/mol, and a melting point of around 65° C.,

Dynacoll® 7360 (available from Evonik) which results from the condensation of adipic acid with hexanediol, and has a number-average molecular mass of around 3500 g/mol, and a melting point of around 55° C.,

Dynacoll® 7330 (available from Evonik) with a number-average molecular mass of around 3500 g/mol, and a melting point of around 85° C.,

Dynacoll® 7363 (available from Evonik) which also results from the condensation of adipic acid with hexanediol, and has a number-average molecular mass of around 5500 g/mol, and a melting point of around 57° C.,

Dynacoll® 7250 (sold by Evonik): polyester polyol having a viscosity of 180 Pa·s at 23° C., a number-average molecular mass Mn equal to 5500 g/mol and a T_{g} equal to −50° C.,

Kuraray® P-6010 (sold by Kuraray): polyester polyol having a viscosity of 68 Pa·s at 23° C., a number-average molecular mass equal to 6000 g/mol and a T_{g} equal to −64° C.,

Kuraray® P-10010 (sold by Kuraray): polyester polyol having a viscosity of 687 Pa·s at 23° C., and a number-average molecular mass equal to 10 000 g/mol.

As examples of polyester diols, mention may also be made of Realkyd® XTR 10410 sold by Cray Valley, with a number-average molecular mass (Mn) in the vicinity of 1000 g/mol and the hydroxyl number of which ranges from 108 to 116 mg KOH/g. It is a product resulting from the condensation of adipic acid, diethylene glycol and monoethylene glycol.

The polycarbonate polyols may be chosen from polycarbonate diols or triols, in particular with a number-average molecular mass (Mₙ) ranging from 300 g/mol to 12 000 g/mol, preferably ranging from 400 to 4000 g/mol.

Examples of polycarbonate diols that may be mentioned include:
Converge Polyol 212-10 and Converge Polyol 212-20 sold by Novomer, with respective number-average molecular masses (Mₙ) equal to 1000 and 2000 g/mol, the hydroxyl numbers of which are, respectively, 112 and 56 mg KOH/g,
Desmophen® C XP 2716 sold by Covestro, with a number-average molecular mass (Mₙ) equal to 326 g/mol, and the hydroxyl number of which is 344 mg KOH/g,
Polyol C-590, C1090, C-2090 and C-3090 sold by Kuraray, with a number-average molecular mass (Mn) ranging from 500 to 3000 g/mol and a hydroxyl number ranging from 224 to 37 mg KOH/g.

The polyaddition reaction of step E1 can be carried out at a temperature T1 below 95° C. and/or under anhydrous conditions.

The polyaddition reaction of step E1 may be performed in the presence or absence of at least one reaction catalyst.

The reaction catalyst(s) which can be used may be any catalyst known to a person skilled in the art for catalyzing the formation of polyurethane by reaction of at least one polyisocyanate with at least one polyol such as for example a polyether polyol.

An amount ranging up to 0.3% by weight of catalyst(s), relative to the weight of the reaction medium of step E1, may be used. In particular, it is preferable to use from 0.02% to 0.2% by weight of catalyst(s), relative to the weight of the reaction medium of step E1.

### Other Steps

The abovementioned process may comprise at least one step of purifying the intermediate reaction products.

Preferably, the process according to the invention does not comprise a step of purifying the intermediate reaction products, or a solvent removal step.

According to one embodiment, said process does not comprise a step consisting in adding one or more solvent(s) and/or plasticizer(s). Such a preparation process can thus be advantageously carried out without interruption, with very high production line speeds on the industrial scale.

According to a preferred embodiment, the process according to the invention consists of a step E2, possibly preceded by a step E1, the steps E1 and E2 being as defined in any one of the preceding sections.

Another subject matter of the present invention is a polyurethane (PP2) comprising at least two, preferably two or three, T end functions of formula (I) capable of being obtained by a preparation process according to the invention as described in any one of the preceding sections.

### C. Multicomponent System

Another subject matter of the present invention is a multicomponent system, preferably a solvent-free multicomponent system, comprising at least:
as first component (component A), a composition comprising at least one polyurethane (PP2) as defined above, and
as second component (component B), a composition comprising at least one amino compound (B1) comprising at least two amine groups selected from primary amine groups, secondary amine groups and mixtures thereof, preferably comprising at least two primary amine groups.

The components of the multicomponent system are generally stored separately and are mixed at the time of use, at a mixing temperature T3, in order to form a composition, preferably an adhesive composition, intended to be applied to the surface of a material.

The mixing of the components of the multicomponent system and in particular of components A and B can be carried out under anhydrous conditions.

Preferably, the amounts of polyurethane(s) having end groups (PP2) and of amino compound(s) (B1) present in the multicomponent system according to the invention result in a molar ratio of the number of T functions to the number of primary and/or secondary amine groups, denoted r3, ranging from 0.5 to 1, in particular from 0.65 to 1 and more preferentially from 0.8 to 1.

Within the context of the invention, and unless otherwise mentioned, the molar ratio, denoted r3, corresponds to the molar ratio of the total number of T functions present in the multicomponent system to the total number of primary and/or secondary amine groups present in the multicomponent system.

The use of such a ratio r3 advantageously makes it possible to obtain, by a polyaddition reaction between the polyurethane(s) (PP2) and the amino compound(s) (B1), a composition, preferably an adhesive composition, advantageously having satisfactory mechanical performance.

The amino compound(s) (B1) used according to the invention preferably has (have) a viscosity suited to the mixing temperature T3. The amino compound(s) (B1) used according to the invention preferably has (have) a primary alkalinity ranging from 0.4 to 34 meq/g, more preferentially from 3.0 to 34 meq/g of amino compound.

The primary alkalinity is the number of primary amine NH₂ functions per gram of amino compound (B1), said number being expressed in the form of milliequivalents of HCl (or milliequivalents of NH₂) used in the assaying of the amine functions, determined in a well-known way by titration.

The amino compound(s) (B1) used according to the invention can be monomeric or polymeric compounds.

The amino compound(s) (B1) may further comprise tertiary amine groups.

The amino compound(s) (B1) used according to the invention can be selected from saturated or unsaturated, linear, branched, cyclic or acyclic hydrocarbon compounds comprising at least two amine groups selected from primary amine groups, secondary amine groups and mixtures thereof, preferably comprising at least two primary amine —NH₂ groups, the hydrocarbon chain between the amine (or advantageously —CH₂—NH₂) functions optionally being interrupted by one or more heteroatoms selected from O, N or S and/or optionally interrupted by one or more divalent —NH— (secondary amine), —COO— (ester), —CONH— (amide), —NHCO— (carbamate), —C═N— (imine), —CO— (carbonyl) and —SO— (sulfoxide) groups, and preferably having a primary alkalinity ranging from 0.4 to 34 meq/g, more preferentially from 3.0 to 34 meq/g, of amino compound.

Mention may for example be made, as examples of such compounds, of:
alkylene polyamines comprising at least two primary amine —NH₂ groups
cycloalkylene polyamines comprising at least two primary amine —NH₂ groups
polyamines comprising both alkyl and cycloalkyl groups and comprising at least two primary amine —NH₂ groups
polyether polyamines comprising at least two primary amine —NH₂ groups
polyethyleneimines comprising at least two primary amine —NH₂ groups
polypropyleneimines comprising at least two primary amine —NH₂ groups
polyamidoamines comprising at least two primary amine —NH₂ groups.

Preferably, the amino compound(s) (B1) used according to the invention has (have) two or three primary amine groups.

More preferentially, the amino compound(s) (B1) used according to the invention is (are) selected from linear, branched, cyclic or acyclic saturated hydrocarbon compounds comprising two or three primary amine —NH₂ groups, said compounds optionally being interrupted by one or more heteroatoms selected from an oxygen —O— atom and a nitrogen —N— atom and/or one or more divalent secondary amine —NH— groups, said amino compound(s) exhibiting a primary alkalinity ranging from 0.4 to 34 meq/g, more preferentially from 3.0 to 34 meq/g, of amino compound.

Mention may for example be made, as examples of such compounds, of:
alkylenediamines and alkylenetriamines, respectively comprising two or three primary amine —NH₂ groups,
cycloalkylenediamines and cycloalkylenetriamines, respectively comprising two or three primary amine —NH₂ groups,
diamines and triamines comprising both alkyl and cycloalkyl groups, respectively comprising two or three primary amine —NH₂ groups,
polyether diamines and polyether triamines, respectively comprising two or three primary amine-NH₂ groups,
polyethyleneimines comprising two or three primary amine —NH₂ groups,
polypropyleneimines comprising two or three primary amine —NH₂ groups,
polyamidoamines comprising two or three primary amine —NH₂ groups.

More particularly, mention may be made of:
ethylenediamine (EDA), having a primary alkalinity of 33.28 meq/g:

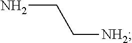

diethylenetriamine (DETA) having a primary alkalinity of 19.39 meq/g:

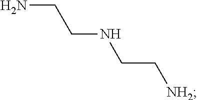

tris(2-aminoethyl)amine (TAEA) having a primary alkalinity of 20.52 meq/g:

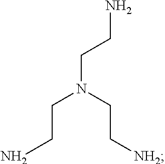

polyethyleneimines corresponding to the formulae below:

H₂N—(CH₂—CH₂—NH)ₓ—CH₂—CH₂—NH₂

N[—(CH₂—CH₂—NH)ₓ—CH₂—CH₂—NH₂]₃
wherein x is an integer such that the primary alkalinity ranges from 0.4 to 34 meq/g, more preferentially from 3.0 to 34 meq/g;
polypropyleneimines corresponding to the formulae below:

H₂N—(CH₂—CH₂—CH₂—NH)ₓ—CH₂—CH₂—CH₂—NH₂

N[—(CH₂—CH₂—CH₂—NH)ₓ—CH₂—CH₂—CH₂—NH₂]₃
wherein x is an integer such that the primary alkalinity is ranges from 0.4 to 34 meq/g, more preferentially from 3.0 to 34 meq/g;
poly(ethylene-propylene)imines corresponding to the formulae below:

H₂N—(CH₂—CH₂—NH)ₓ—(CH₂—CH₂—CH₂—NH)_{y}H

N[—(CH₂—CH₂—NH)ₓ—(CH₂—CH₂—CH₂—NH)_{y}H]₃
wherein x and y are integers such that the primary alkalinity ranges from 0.4 to 34 meq/g, more preferentially from 3.0 to 34 meq/g;
hexamethylenediamine (HMDA), having a primary alkalinity of 17.11 meq/g:

NH₂—CH₂—CH₂—CH₂—CH₂—CH₂—CH₂—NH₂;
isophoronediamine (IPDA), having a primary alkalinity of 11.73 meq/g:

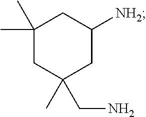

polyether diamines having a primary alkalinity ranging from 11.4 to 13.5 meq/g and corresponding to the formula below:

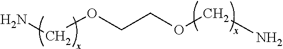

wherein x=2 or 3; such polyetherdiamines are sold for example under the name Jeffamines EDR-148 and EDR-176 by Huntsman and have respective primary alkalinities of 13.5 and 11.4 meq/g;
polyether diamines having a primary alkalinity ranging from 0.5 to 8.7 meq/g and corresponding to the formula below:

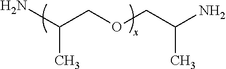

wherein x is an integer ranging from 2 or 68, such that the primary alkalinity ranges from 0.5 to 8.7 meq/g; such polyetherdiamines are sold for example under the name Jeffamines D-230, D-400, D-2000 and D-4000 by Huntsman and have respective primary alkalinities of 8.7, 5.0, 1.0 and 0.5 meq/g;
polyether diamines having a primary alkalinity ranging from 1.0 to 9.1 meq/g and corresponding to the formula below:

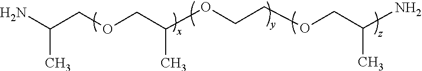

wherein x, y and z are integers, y ranging from 2 to 39 and x+z ranging from 1 to 6, such that the primary alkalinity ranges from 1.0 to 9.1 meq/g; such polyetherdiamines are sold for example under the name Jeffamines HK-511, ED-600, ED-900 and ED-2003 by Huntsman and have respective primary alkalinities of 9.1, 3.3, 2.2 and 1.0 meq/g;
polyether triamines having a primary alkalinity ranging from 0.6 to 6.8 meq/g and corresponding to the formula below:

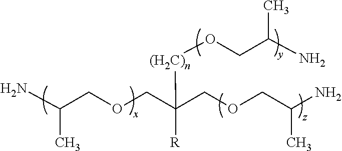

wherein R is a hydrogen atom or a C1 to C2 alkyl group, x, y, z and n are integers, n ranging from 0 to 1 and x+y+z ranging from 5 to 85, such that the primary alkalinity ranges from 0.6 to 6.8 meq/g; such polyether diamines are sold for example under the name Jeffamines T-403, T-3000, and T-5000 by Huntsman and have respective primary alkalinities of 6.8, 1.0 and 0.6 meq/g;
dimer and trimer fatty amines comprising two or three primary amine groups with a primary alkalinity ranging from 3.39 meq/g to 3.60 meq/g. These dimer and trimer fatty amines can be obtained from corresponding dimerized and trimerized fatty acids. Mention may be made, as examples of such dimer fatty amines, of those corresponding to the following formulae:

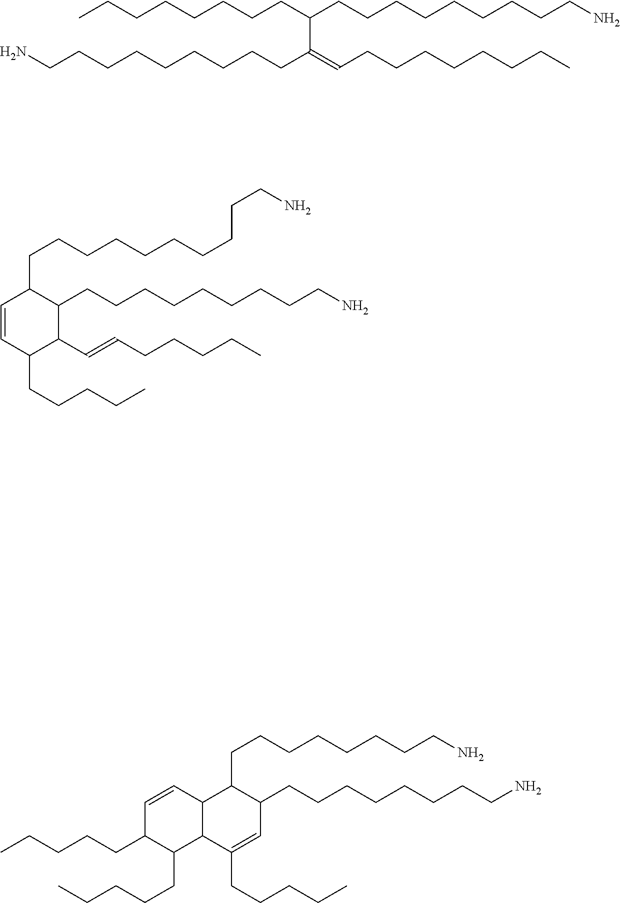 [SMILES: CCCCCCCC/C=C(/CCCCCCCCCN)C(CCCCCCCC)CCCCCCCCCN ; CCCCC/C=C/C1C(CCCCC)C=CC(CCCCCCCCCCN)C1CCCCCCCCCN ; CCCCCC1=CC(CCCCCCCCN)C(CCCCCCCCN)C2C=CC(CCCCC)C(CCCCC)C12]

The dimer and trimer fatty acids used to prepare the abovementioned fatty amines are obtained by high-temperature polymerization under pressure of unsaturated fatty monocarboxylic acids (monomeric acid) comprising from 6 to 22 carbon atoms, preferably from 12 to 20 carbon atoms, and originate from plant or animal sources. Mention may be made, as examples of such unsaturated fatty acids, of Cis acids having one or two double bonds (respectively oleic acid or linoleic acid) obtained from tall oil, which is a byproduct of the manufacture of paper pulp. After polymerization of these unsaturated fatty acids, an industrial mixture is obtained which contains, on average, 30-35% by weight of fatty monocarboxylic acids, often isomerized relative to the starting unsaturated fatty monocarboxylic acids, 60-65% by weight of dicarboxylic acids (dimer acids) comprising twice the number of carbons relative to the starting unsaturated fatty monocarboxylic acids, and 5-10% by weight of tricarboxylic acids (trimer acids) having three times the number of carbons relative to the starting unsaturated fatty monocarboxylic acids. The various commercial grades of dimer, monomer or trimer acids are obtained by purification of this mixture. These dimer and trimer fatty acids are subsequently subjected to a reducing ammoniation (NH₃/H₂) reaction in the presence of a catalyst, making it possible to obtain the dimerized fatty amines.

According to one embodiment, the compound(s) (B1) comprise at least two methylene amine groups (—CH₂—NH₂).

According to a preferred embodiment, the compound(s) (B1) are selected from tris(2-aminoethyl)amine (TAEA), hexamethylenediamine (HMDA), polyethyleneimines, dimer fatty amines, and mixtures thereof.

When the multicomponent system according to the invention comprises at least two amino compounds (B1), the latter can be included in two different components, for example a component (B) and a component (C). The components (A), (B) and (C) are then stored separately before mixing at the time of the use of said system, at a mixing temperature T3, in order to form a composition, preferably an adhesive composition, intended to be applied to the surface of a material.

The multicomponent system according to the invention can comprise at least one crosslinking catalyst.

The crosslinking catalyst(s) can be any catalyst generally used to accelerate the ring-opening reaction of a compound comprising a T function with a primary and/or secondary amine.

Mention may be made, as examples of crosslinking catalysts which can be used according to the invention, of:
alkoxides, such as potassium tert-butoxide or sodium methoxide;
strong bases chosen from:
   phosphazenes, such as 2-(tert-butylimino)-2-diethylamino-1,3-dimethylperhydro-1,3,2-diazaphosphorine (BMEP),
   guanidines, such as:
1,5,7-triazabicyclo[4.4.0]dec-5-ene (TBD)

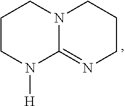

N-methyltriazabicyclodecene (Me-TBD)

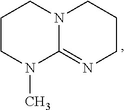

tertiary amines, such as:
1,8-diazabicyclo[5.4.0]undec-7-ene (DBU)

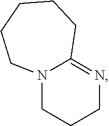 [SMILES: C1CCC2=NCCCN2CC1]

1,5-diazabicyclo[4.3.0]non-5-ene (DBN)

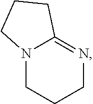

2,2′-dimorpholinodiethyl ether (DMDEE)

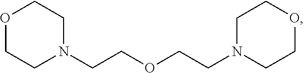 [SMILES: C1CN(CCOCCN2CCOCC2)CCO1]

1,4-diazabicyclo[2.2.2]octane (DABCO)

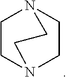

An amount ranging from 0.05% to 1% by weight of crosslinking catalyst(s), with respect to the total weight of the multicomponent system according to the invention, can be used.

The crosslinking catalyst(s) can be distributed in one or more of the components forming the multicomponent system according to the invention.

Advantageously, the multicomponent system according to the invention can comprise at least one mineral filler.

The mineral filler(s) which can be used is (are) advantageously selected so as to improve the mechanical performance of the composition according to the invention in the crosslinked state.

As examples of fillers that may be used, mention may be made, in a nonlimiting manner, of calcium carbonate, kaolin, silica, gypsum, microspheres and clays.

Preferably, the mineral filler(s) has (have) a maximum particle size, notably an external diameter, of less than 100 μm and preferably less than 10 μm. Such fillers may be selected, in a manner well known to a person skilled in the art, by using sieves having appropriate mesh sizes.

Preferably, the total content of filler(s) optionally present in the multicomponent system according to the invention does not exceed 70% by weight of the total weight of said system.

The filler(s) can be distributed in one or more of the components forming the multicomponent system according to the invention.

The multicomponent system according to the invention may include less than 2% by weight of one or more additives advantageously selected in order not to damage the properties of the adhesive composition according to the invention in the crosslinked state. Mention may for example be made, among the additives which can be used, of antioxidants or UV (ultraviolet) stabilizers, pigments and dyes. These additives are preferably chosen from those usually used in adhesive compositions.

The additive(s) can be distributed in one or more of the components forming the multicomponent system according to the invention.

Preferably, the abovementioned multicomponent system does not comprise solvent and/or plasticizer.

As a result of the low viscosity of the polyurethane (PP2) according to the invention, the multicomponent system according to the invention can advantageously be used directly by mixing its various components, without addition of solvent and/or plasticizer, viscosity reducers, to the component (A) and/or without heating said component to temperatures above 95° C.

Preferably, the polyurethane (PP2) according to the invention has a viscosity, measured at 23° C., of less than or equal to 600 Pa·s and a viscosity, measured at 60° C., of less than or equal to 40 Pa·s, allowing the multicomponent system according to the invention to be advantageously used without addition of solvent and/or of plasticizer to the component (A) comprising said polyurethane (PP2) and/or without heating said component.

According to one embodiment, the multicomponent system according to the invention comprises:
as first component (A), a composition comprising at least one polyurethane (PP2) according to the invention and
as second component (B), a composition comprising at least one or two amino compound(s) as described in one of the preceding sections (B1), and

said multicomponent system being devoid of solvent and/or plasticizer.

The multicomponent system according to the invention can be a two-component system, that is to say a system consisting of two components (A) and (B), said components (A) and (B) being as described in one of the preceding sections.

Preferably, the component (A) comprises at least 97% by weight and more preferentially at least 98% by weight of polyurethane(s) (PP2) according to the invention relative to the total weight of said component (A).

According to one embodiment, the multicomponent system is an adhesive composition, preferably a glue or mastic composition.

The invention also relates to the use of a polyurethane (PP2) according to the invention for the manufacture of an adhesive composition, preferably a solvent-free adhesive composition, in particular in the form of a multicomponent system.

Preferably, the adhesive composition is manufactured without addition of compound intended to lower the viscosity of said composition, such as a solvent (aqueous or organic), a reactive diluent and/or a plasticizer.

Preferably, the components of the multicomponent system according to the invention comprising the compound(s) (PP2) according to the invention and the amino compound(s) (B1) according to the invention are mixed at a temperature T3 as defined above.

Preferably, the composition, preferably adhesive composition, according to the invention is manufactured by the use of the multicomponent system according to the invention, that is to say the mixing of the various components constituting it, at a mixing temperature T3.

### D. Uses

Another subject matter of the invention is a process for assembling materials employing the polyurethane (PP2) according to the invention, in particular via the use of the multicomponent system according to the invention, comprising the following steps:
the mixing of at least one (PP2) as described above and of at least one amino compound (B1) as described above, then
the coating of said mixture on the surface of a first material, then
the laminating of the surface of a second material on said coated surface, then
the crosslinking of said mixture.

The step of mixing at least one polyurethane (PP2) as described above and of at least one amino compound (B1) as described above can be carried out in particular by the use of the multicomponent system according to the invention, namely by mixing the components respectively comprising the polyurethane(s) (PP2) (component (A)) and the amino compound(s) (component (B)), as defined above.

This mixing step can be carried out at room temperature or under hot conditions, before coating.

Preferably, the mixing is carried out at a temperature below the decomposition temperature of the ingredients included in one or other of the components (A) and (B). In particular, the mixing is carried out at a temperature T3 below 95° C., preferably ranging from 15 to 80° C., in order to advantageously avoid any thermal decomposition.

Preferably, the polyurethane(s) (PP2) and the amino compound(s) (B1) are mixed in amounts such that the molar ratio r3 of the number of T functions to the number of amine groups present in the mixture ranges from 0.5 to 1 and more preferentially from 0.8 to 1.

In each of these alternative forms, the coating of said mixture can be carried out over all or part of the surface of a material. In particular, the coating of said mixture can be carried out in the form of a layer with a thickness ranging from 0.002 to 5 mm.

Optionally, the crosslinking of said mixture on the surface of the material can be accelerated by heating the coated material(s) to a temperature below or equal to 120° C. The time required in order to complete this crosslinking reaction and to thus ensure the required level of cohesion is generally of the order of 0.5 to 24 hours.

The coating and the laminating of the second material are generally carried out within a time interval compatible with the coating process, as is well known to a person skilled in the art, that is to say before the adhesive layer loses its ability to fix the two materials by adhesive bonding.

The appropriate materials are, for example, inorganic substrates, such as glass, ceramics, concrete, metals or alloys (such as aluminum alloys, steel, nonferrous metals and galvanized metals), and also metals and composites which are optionally coated with paint (as in the motor vehicle field); or else organic substrates, such as wood, or plastics, such as PVC, polycarbonate, PMMA, epoxy resins and polyesters.

The mechanical performances and the adhesive strength of the compositions according to the invention can be measured in accordance with the tests described in the examples which follow, namely once crosslinked. The compositions according to the invention are advantageously suited to a broad panel of applications, such as the agri-food industry, cosmetics, hygiene, transportation, housing, textiles or packaging.

It has been observed that the polyurethane (PP2) according to the invention advantageously has an improved reactivity with regard to amino compounds comprising at least two primary and/or secondary amine groups at a temperature close to ambient (ranging for example from 15° C. to 35° C.).

Furthermore, it has been observed that, by using the polyurethane (PP2) according to the invention, it was advantageously possible to manufacture adhesive compositions, preferably without solvent, having good wettability properties and good mechanical performance, suitable for surface coating, and satisfactory adhesive properties for the assembling by adhesive bonding of at least two materials.

All the embodiments described above can be combined with one another.

In the context of the invention, the term “between x and y” or “ranging from x to y” is understood to mean an interval in which the limits x and y are included. For example, the range “between 0% and 25%” includes in particular the values 0% and 25%.

The following examples are given purely by way of illustration of the invention and

should not be interpreted in order to limit the scope thereof.

### Experimental Part

A—Synthesis of Polyurethane (PP2) (Component A)

The components (A) of examples 1 to 3 according to the invention are prepared using the reactants shown in table 1 and according to the procedure described in the following pages. The amounts shown in table 1 are expressed in grams of commercial products.

TABLE 1

| Ingredients | 1 | 2 | 3 |
|---|---|---|---|
| Hexamethylene diisocyanate (HDI) allophanate | 71.3 | 70.4 | 34.6 |
| derivative of formula (IIA) | | | |
| PPG diol | — | — | 58.4 |
| Reaction catalyst | 0.1 | 0.1 | 0.1 |
| NCO/OH ratio, r1 | N.A. | N.A. | 1.89 |
| 4-hydroxymethyl-5-methyl-1,3-dioxolen-2-one | 28.6 | 29.5 | 6.9 |
| NCO/OH molar ratio, r2 | 0.97 | 0.93 | 0.91 |

N.A.: not applicable

In table 1, use is made, as:

hexamethylene diisocyanate (HDI) allophanate derivative of formula (IIA), of the commercial product sold under the name Tolonate® X FLO by Vencorex, corresponding to a composition comprising a minimum of 99.5% by weight of hexamethylene diisocyanate (HDI) allophanate derivative of formula (IIA) and less than 0.5% by weight of HDI, and having a content of NCO groups equal to 13.4% by weight, with respect to the weight of Tolonate® X FLO,

PPG diol, of the commercial product sold under the name Voranol® P2000 by Dow, corresponding to polypropylene glycol diol having a hydroxyl number approximately equal to 56 mg KOH/g of PPG diol,

reaction catalyst, of the commercial product sold under the name Borchi Kat® 315 by OM Group, corresponding to a bismuth neodecanoate reaction catalyst,

4-hydroxymethyl-5-methyl-1,3-dioxolen-2-one (CAS number: 91526-18-0), synthesized according to WO 96/02253 having a hydroxyl number approximately equal to 431 mg KOH/g.

The molar ratios r1 and r2 are calculated in a way well known to a person skilled in the art from the molar amounts of reactants used. By expressing the number of mole(s) of derivative of formula (IIA) used as a function of the content of NCO groups (% NCO) of the latter and of the molar mass of NCO equal to 42 g/mol; the number of mole(s) of polyether polyol used as a function of the hydroxyl number (mg KOH/g) of the latter and of the molar mass of KOH equal to 56 g/mol; and the number of mole(s) of 4-hydroxymethyl-5-methyl-1,3-dioxolen-2-one used as a function of the hydroxyl number (mg KOH/g) of the latter and of the molar mass of KOH equal to 56 g/mol, it is possible to write:

$$r 1 = \frac{\begin{matrix}\% NCO ( derivative of formula ( II ) ) \times \\ m 1 ( derivative of formula ( II ) ) \times 10 \times 56\end{matrix}}{42 \times OHN ( polyether polyol ) \times m 2 ( polyether polyol )}$$

$$r 2 = \frac{\begin{matrix}\frac{[ \begin{matrix}\% NCO ( derivative of formula ( I ) ) \times \\ m 1 ( derivative of formula ( I ) ) \times 10\end{matrix} ]}{42} - \\ \frac{[ OHN ( polyether polyol ) \times m 2 ( polyether polyol ) ]}{56}\end{matrix}}{\begin{matrix}OHN ( 4 - hydroxymethyl - 5 - methyl - 1 , 3 - dioxolen - 2 - one ) \times \\ m 3 ( 4 - hydroxymethyl - 5 - methyl - 1 , 3 - dioxolen - 2 - one )\end{matrix}} \times 56$$

where:
% NCO (derivative of formula (II)) corresponds to the content of NCO groups of the Tolonate® X FLO,
m1 (derivative of formula (II)) corresponds to the mass of Tolonate® X FLO introduced, OHN (polyether polyol) corresponds to the hydroxyl number of the Voranol® P2000,
m2 (polyether polyol) corresponds to the mass of Voranol® P2000 introduced, OHN (4-hydroxymethyl-5-methyl-1,3-dioxolen-2-one) corresponds to the hydroxyl number of 4-hydroxymethyl-5-methyl-1,3-dioxolen-2-one
m3 (4-hydroxymethyl-5-methyl-1,3-dioxolen-2-one) corresponds to the mass of 4-hydroxymethyl-5-methyl-1,3-dioxolen-2-one.

### Examples 1 and 2: Synthesis of the Polyurethane (PP2) (Component A) in One Step (E2)

The diisocyanate is heated to 50° C. in a reactor placed under a nitrogen atmosphere and then the 4-hydroxymethyl-5-methyl-1,3-dioxolen-2-one is introduced in the proportions indicated in table 1. The mixture is subsequently brought to 80° C. and the catalyst is added. This mixture is kept continuously stirred at 80° C., under nitrogen, until complete disappearance of the NCO functions visible in the infrared (IR) (approximately 2250 cm⁻¹).

100 g of polyurethane (PP2) (component A) are obtained at the end of the reaction for each of the examples.

### Example 3: Synthesis of the Polyurethane (PP2) (Component A) in Two Steps (E1 and E2)

Step E1: Synthesis of the Compound (PP1)

The diisocyanate is heated to 50° C. in a reactor placed under a nitrogen atmosphere and then a mixture of polyether polyol and of reaction catalyst, in accordance with the amounts

shown in table 1, is introduced dropwise with continuous stirring. The temperature does not exceed 80° C.

This mixture is kept continuously stirred at 80° C., under nitrogen, until the NCO functions of the diisocyanate have completely reacted.

The reaction is monitored by measuring the change in the content of NCO groups in the mixture, for example by back titration of dibutylamine using hydrochloric acid, according to the standard NF T52-132. The reaction is halted when the “degree of NCO” (% NCO) measured is approximately equal to the desired degree of NCO (2.2% by weight of the weight of the reaction mixture).

Step E2: Synthesis of the Polyurethane (PP2) (Component A)

Once the reaction of step E1 is complete, the 4-hydroxymethyl-5-methyl-1,3-dioxolen-2-one is introduced into the reactor in the proportions shown in table 1, with stirring and under nitrogen. The temperature does not exceed 80° C.

The compound (PP1)/4-hydroxymethyl-5-methyl-1,3-dioxolen-2-one mixture is kept continuously stirred at 80° C., under nitrogen, until complete disappearance of the NCO functions visible in the infrared (IR) (approximately 2250 cm⁻¹).

100 g of polyurethane (PP2) (component A) are obtained at the end of the reaction.

Viscosity Measurement:

The viscosity of the component (A) obtained is measured 24 hours after the end of the reaction (D+1) at 23° C. and 60° C. and is expressed in pascal·seconds (Pa·s). All of the values measured for examples 1 to 3 are combined in table 2 below.

The viscosity measurement at 23° C. is carried out using a Brookfield RVT viscometer, with a spindle suited to the viscosity range and at a rotational speed of 20 revolutions per 15 minute (rpm).

The viscosity measurement at 60° C. is carried out using a Brookfield RVT viscometer coupled with a heating module of Thermosel type of the Brookfield brand, with a spindle suited to the viscosity range and at a rotational speed of 20 revolutions per minute.

TABLE 2

| Characterization of the polyurethane (PP2) | 1 | 2 | 3 |
|---|---|---|---|
| Viscosity at D + 1 at 23° C. (Pa · s) | 300 | 310 | 120 |
| Viscosity at D + 1 at 60° C. (Pa · s) | 3.6 | 3.5 | 3.6 |
| Calculated content of T functions in the | 2.20 | 2.27 | 0.53 |
| polyurethane (PP2) (meq/g of polyurethane | | | |
| (PP2)), denoted t_{cc} (PP2) | | | |

The content of T functions in the polyurethane (PP2) (denoted t_{cc} (PP2)) (expressed in meq/g of polyurethane (PP2)) is calculated in a way well known to a person skilled in the art from the molar amount of 4-hydroxymethyl-5-methyl-1,3-dioxolen-2-one used. By expressing the number of mole(s) of 4-hydroxymethyl-5-methyl-1,3-dioxolen-2-one used as a function of the hydroxyl number (mg KOH/g) of the latter and of the molar mass of KOH equal to 56 g/mol, it is possible to write:

$${t}_{cc} ( PP 2 ) = \frac{\begin{matrix}OHN ( 4 - hydroxymethyl - 5 - methyl - 1 , 3 - dioxolen - 2 - one ) \times \\ m 3 ( 4 - hydroxymethyl - 5 - methyl - 1 , 3 - dioxolen - 2 - one )\end{matrix}}{56 \times m ( PP 2 )}$$

where:
OHN (4-hydroxymethyl-5-methyl-1,3-dioxolen-2-one) corresponds to the hydroxyl number of 4-hydroxymethyl-5-methyl-1,3-dioxolen-2-one,
m3 (4-hydroxymethyl-5-methyl-1,3-dioxolen-2-one) corresponds to the mass of 4-hydroxymethyl-5-methyl-1,3-dioxolen-2-one introduced,
m (PP2) corresponds to the mass of polyurethane (PP2), i.e. to the total mass of the ingredients used for the synthesis of the polyurethane PP2 (derivative of formula (IIA), PPG diol, reaction catalyst).

B—Preparation of the Compositions According to the Invention by Mixing the Components A and B

The adhesive compositions 1′ to 12′ according to the invention are prepared by mixing the various ingredients shown in table 3 below, at a temperature T3 as shown below, under a nitrogen atmosphere. The mixture is kept continuously stirred under vacuum (for debubbling) for 2 minutes. The mixture is then left stirring until complete disappearance of the T functions visible in the infrared (signal at 1800 cm⁻¹).

The amounts shown in table 3 are expressed in grams.

TABLE 3

| | 1′ | 2′ | 3′ | 4′ | 5′ | 6′ | 7′ | 8′ | 9′ | 10′ |
|---|---|---|---|---|---|---|---|---|---|---|
| Component A of | 100 | 100 | 100 | 100 | 100 | 100 | 100 | — | — | — |
| example 1 | | | | | | | | | | |
| Component A of | — | — | — | — | — | — | — | 100 | 100 | — |
| example 2 | | | | | | | | | | |
| Component A of | — | — | — | — | — | — | — | — | — | 100 |
| example 3 | | | | | | | | | | |
| TAEA | 11.2 | 11.2 | 11.2 | 11.2 | 5.5 | 5.5 | 5.5 | — | — | 2.7 |
| HMDA | — | — | — | — | — | 11.2 | — | — | — | — |
| PEI | — | — | — | — | — | — | — | 32.2 | 32.2 | — |
| Dimer fatty amine | — | — | — | — | 32.1 | — | 32.1 | — | — | — |
| Calcium carbonate | — | — | 50 | 100 | 100 | — | — | 100 | 50 | 100 |
| Molar ratio r3 | 0.96 | 0.96 | 0.96 | 0.96 | 0.96 | 0.73 | 0.96 | 0.93 | 0.93 | 0.97 |
| Temperature T3 (° C.) | 23 | 80 | 80 | 80 | 80 | 80 | 80 | 80 | 80 | 80 |

In table 3, use is made of:

tris(2-aminoethyl)amine (TAEA) with a primary alkalinity=20.52 meq/g of TAEA,

hexamethylenediamine (HMDA) with a primary alkalinity=17.21 meq/g of HMDA,

polyethyleneimine (PEI), sold under the name E100 by Huntsman, with a primary alkalinity=7.58 meq/g of PEI,

dimer fatty amine, sold under the name Priamine® 1071 by Croda, with a primary alkalinity=3.65 meq/g of Priamine,

calcium carbonate with a maximum particle size=100 μm.

The molar ratio r3 is calculated in a way well known to a person skilled in the art from the molar amounts of 4-hydroxymethyl-5-methyl-1,3-dioxolen-2-one and of compound(s) having at least two primary amine (—NH₂) groups. By expressing the number of mole(s) of 4-hydroxymethyl-5-methyl-1,3-dioxolen-2-one as a function of the content of T functions in the polyurethane (PP2) calculated above; and the number of mole(s) of amino compound(s) used as a function of the primary alkalinity (meq/g) of the latter, it is possible to write:

$$r 3 = \frac{{t}_{c c} ( P P 2 ) \times m ( P P 2 )}{{Σ}_{k} [ {m}_{k} ( amino curing agent ) \times {PA}_{k} ( amino curing agent ) ]}$$

where:
t_{cc} is the calculated content of T functions in the polyurethane (PP2) (meq/g) as defined above,
m (PP2) corresponds to the mass of polyurethane (PP2) as defined above,
PAk is the primary alkalinity of each amino compound,
mk (amino compound) corresponds to the mass of each amino compound k with alkalinity PAk used,
Σₖ[mₖ (amino compound)×PAₖ (amino compound)] corresponds, for k=1, to the product of the mass of the amino compound used and the primary alkalinity of said amino compound and, for k>1, to the sum of the products of the mass of each amino compound used and their respective primary alkalinity, k is an integer greater than or equal to 1.

Measurement of the mechanical performance: breaking strength and elongation at break of the compositions according to the invention in the crosslinked state.

Once crosslinked, the breaking strength and the elongation at break are measured by a tensile test on the adhesive composition according to the protocol described below.

The principle of the measurement consists in drawing, in a tensile testing device, the movable jaw of which is displaced at a constant rate equal to 100 mm/minute, a standard test specimen consisting of the crosslinked adhesive composition; and in recording, at the moment when the test specimen breaks, the applied tensile stress (in MPa) and also the elongation of the test specimen (in %).

The standard test specimen is dumbbell-shaped, as illustrated in the international standard ISO 37. The narrow part of the dumbbell used has a length of 20 mm, a width of 4 mm and a thickness of 500 μm.

In order to prepare the dumbbell, the composition conditioned as described above is heated to 95° C. and then the amount necessary to form, on an A4 sheet of silicone-treated paper, a film having a thickness of 500 μm is extruded over this sheet, which film is left at 23° C. and 50% relative humidity for 7 days for crosslinking. The dumbbell is then obtained by simple cutting from the crosslinked film using a punch.

The tensile strength test is repeated twice and gives the same results. The applied tensile stress recorded is expressed in megapascals (MPa, i.e. 10⁶ Pa) and the elongation at break is expressed in % with respect to the initial length of the test specimen. The values are combined in table 4 below.

TABLE 4

| | 1′ | 2′ | 3′ | 4′ | 5′ | 6′ | 7′ | 8′ | 9′ | 10′ |
|---|---|---|---|---|---|---|---|---|---|---|
| Applied tensile stress | 2.4 | 2.7 | 5.4 | 7.0 | 4.1 | 1.7 | 1.4 | 4.6 | 3.6 | 4.9 |
| (MPa) | | | | | | | | | | |
| Elongation at break (%) | 360 | 440 | 370 | 200 | 590 | 690 | 420 | 445 | 620 | 500 |

Adhesive strength: Measurement of the shear force under stress (lap shear)

Compositions T, 2′ and 8′ according to the invention were furthermore subjected to tests of adhesive bonding of two strips made of powdered aluminum (each with a size of 100 mm×25 mm) cleaned beforehand with a solvent (isopropanol). The adhesive composition is applied to one of the surfaces of the strips using a spatula, within a space delimited by a Teflon window of 12.5 mm×25 mm. The other strip is affixed over the adhesive-coated surface by pressing the two strips against one another. After crosslinking at 23° C. and 50% relative humidity for seven days, the shear force at failure and also the failure pattern are measured.

TABLE 5

| | 1′ | 2′ | 6′ |
|---|---|---|---|
| Shear force at failure (MPa) | 5.2 | 7 | 2.5 |
| Type of failure | CF | CF | CF |

“C” denotes cohesive failure, meaning that it is observed that the adhesive joint has remained adhesively bonded to both faces of the laminated strips.

Thus, the adhesive compositions according to the invention can be easily formulated using a preparation process which is relatively inexpensive in terms of energy, which is friendly to man and to his environment and which does not employ solvent or plasticizer.

In addition, the adhesive compositions according to the invention thus obtained result in adhesives which are effective in terms of mechanical properties and/or of adhesive strength and which are suitable for a broad panel of applications.

1-16. (canceled)

17. A polyurethane (PP2) comprising:
at least two T end functions of formula (I) below: 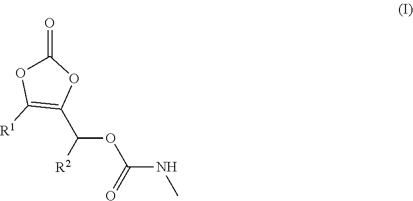
wherein R¹ and R², which are identical or different, each represent a hydrogen atom, a linear or branched alkyl group, a cycloalkyl group, a phenyl group, or an alkylphenyl group with a linear or branched alkyl chain; or R¹ and R² may be bonded together to form a —(CH₂)ₙ— group with n=3, 4 or 5, and
at least one divalent unit of formula (II) below: 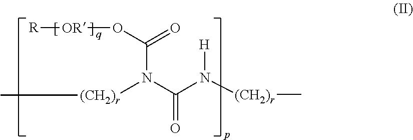
wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms; and
R′ represents a linear or branched, saturated, divalent hydrocarbon group having from 2 to 4 carbon atoms.

18. The polyurethane as claimed in claim 17, further comprising at least one of the following divalent radicals R³:
a) the —(CH₂)₅— divalent radical derived from pentamethylene diisocyanate (PDI);
b) the —(CH₂)₆— divalent radical derived from hexamethylene diisocyanate (HDI);
c) the divalent radical derived from isophorone: 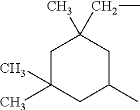
d) the divalent radical derived from TDI;
e) the divalent radical derived from MDI;
f) the divalent radical derived from xylylene diisocyanate (XDI);
g) the divalent radical derived from 1,3-bis(isocyanatomethyl)cyclohexane (m-H6XDI): 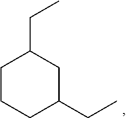
or
h) the divalent radical derived from 4,4′-methylene dicyclohexyl diisocyanate (H12MDI):

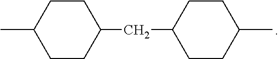

19. The polyurethane as claimed in claim 18, having the following formula (III): 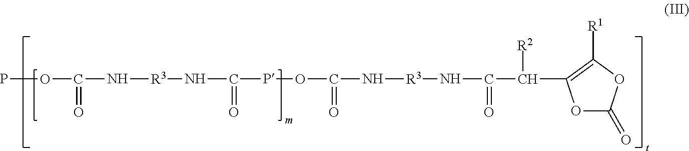
wherein:
R¹ and R², which are identical or different, each represent a hydrogen atom, a linear or branched alkyl group, a cycloalkyl group, a phenyl group, or an alkylphenyl group with a linear or branched alkyl chain; or R¹ and R² may be bonded together to form a —(CH₂)ₙ— group with n=3, 4 or 5;
P represents one of the two formulae below: 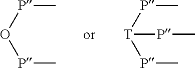
wherein D and T represent, independently of one another, a linear or branched, cyclic, alicyclic or aromatic, saturated or unsaturated hydrocarbon radical comprising from 2 to 66 carbon atoms, optionally comprising one or more heteroatoms;
P′ and P″ being, independently of one another, a divalent radical derived from a polyol;
m and f are integers such that the average molecular mass of the polyurethane ranges from 600 to 100 000 g/mol;
f is equal to 2 or 3; and
R^{a} represents a divalent radical selected from the R³ radicals as defined in claim 18, and a divalent unit of formula (II), at least one R^{a} being a divalent unit of formula (II), wherein the divalent unit of formula (II) is defined as: 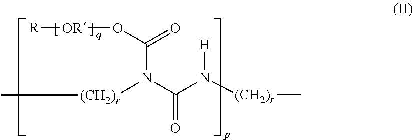
wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms; and
R′ represents a linear or branched, saturated, divalent hydrocarbon group having from 2 to 4 carbon atoms.

20. The polyurethane (PP2) as claimed in claim 17, wherein it can be obtained by reaction of a compound (PP1) comprising at least two NCO groups and at least one divalent unit of formula (II) as defined in claim 17, with at least one compound of formula (IV) below: 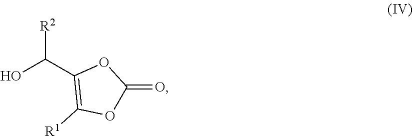
wherein R¹ and R² are as defined in claim 17.

21. A process for preparing the polyurethane (PP2) of claim 20, comprising a step of polyaddition reaction (denoted E2):
of at least one compound (PP1) having at least two NCO groups and at least one divalent unit of formula (II): 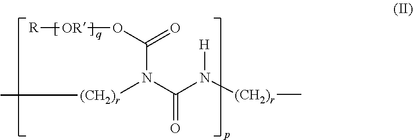
wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms;
R′ represents a linear or branched, saturated, divalent hydrocarbon group having from 2 to 4 carbon atoms;
with at least one compound of formula (IV) as defined in claim 20, in amounts of compound(s) (PP1) and of compound(s) of formula (IV) resulting in an NCO/OH molar ratio, denoted r₂, of less than or equal to 1.

22. The process as claimed in claim 21, wherein the compound(s) (PP1) is (are) selected from hexamethylene diisocyanate (HDI) allophanate derivatives of formula (IIA) below: 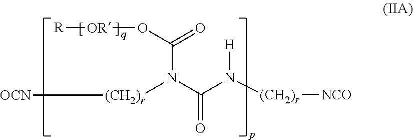
wherein:
p is an integer ranging from 1 to 2;
q is an integer ranging from 0 to 9;
r is an integer equal to 5 or 6;
R represents a saturated or unsaturated, cyclic or acyclic, linear or branched hydrocarbon chain comprising from 1 to 20 carbon atoms; and
R′ represents a linear or branched, saturated, divalent hydrocarbon group having from 2 to 4 carbon atoms.

23. The process as claimed in claim 22, wherein the compound(s) (PP1) is (are) selected from polyurethanes having NCO end groups capable of being obtained by a polyaddition reaction (denoted step E1):
i. of a polyisocyanate(s) composition comprising at least one hexamethylene diisocyanate (HDI) allophanate derivative of formula (IIA) as defined in claim 22, and
ii. with a polyol(s) composition,
in amounts of polyisocyanate(s) and of polyol(s) resulting in an NCO/OH molar ratio, denoted r1, of strictly greater than 1.

24. The process as claimed in claim 21, wherein it does not comprise a step comprising adding one or more solvent(s) and/or plasticizer(s).

25. The process as claimed in claim 23, wherein the polyol(s) is (are) selected from polyoxyalkylene polyols, the linear or branched alkylene portion of which comprises from 1 to 4 carbon atoms.

26. A multicomponent, solvent-free, system comprising:
as first component (component A), a composition comprising at least one polyurethane (PP2) as defined in claim 17, and
as second component (component B), a composition comprising at least one amino compound (B1) comprising at least two amine groups selected from primary amine groups, secondary amine groups and mixtures thereof.

27. The multicomponent system as claimed in claim 26, wherein said amino compound(s) (B1) has (have) a primary alkalinity ranging from 0.4 to 34 meq/g of amino compound.

28. The multicomponent system as claimed in claim 26, wherein the amino compound(s) (B1) comprise at least two methylene amine groups (—CH₂—NH₂).

29. The multicomponent system as claimed in claim 26, wherein the amino compound(s) (B1) are selected from tris(2-aminoethyl)amine (TAEA), hexamethylenediamine (HMDA), polyethyleneimines, dimer fatty amines, and mixtures thereof.

30. The multicomponent system of claim 26, wherein the amounts of polyurethane(s) (PP2) and of amino compound(s) (B1) present in the multicomponent system result in a molar ratio of the number of T functions of formula (I) to the number of primary and/or secondary amine groups, denoted r₃, ranging from 0.5 to 1.

31. A process for assembling materials employing the polyurethane (PP2) of claim 17, comprising the following steps:
mixing the at least one polyurethane (PP2) of claim 17, and at least one amino compound (B1) comprising at least two amine groups selected from primary amine groups, secondary amine groups and mixtures thereof to form a first mixture;
coating said first mixture on a surface of a first material to form a coated surface, then
laminating a surface of a second material on said coated surface, then
crosslinking said mixture.
